(19) United States
(12) Patent Application Publication
(10) Pub. No.: US 2016/0214325 A1
(43) Pub. Date: Jul. 28, 2016

(54) MODELING DATA CREATION METHOD AND INFORMATION PROCESSING DEVICE

(71) Applicant: FUJITSU LIMITED, Kawasaki-shi (JP)

(72) Inventors: Tsukasa Tenma, Kawasaki (JP); Ryusuke Akahoshi, Machida (JP); Mari Morimoto, Kawasaki (JP); Yuichi ARITA, Hachioji (JP)

(73) Assignee: FUJITSU LIMITED, Kawasaki-shi (JP)

(21) Appl. No.: 14/970,634

(22) Filed: Dec. 16, 2015

(30) Foreign Application Priority Data
Jan. 28, 2015 (JP) 2015-014638

(51) Int. Cl. B29C 67/00; G05B 19/4099

(52) U.S. Cl. CPC B29C 67/0088; G05B 19/4099; G05B 2219/35134; G05B 2219/49007; B33Y 50/02

(57) ABSTRACT

A modeling data creation method, includes: creating, by a computer, portion section data indicating portion sections which are obtained by dividing a space enclosing a three-dimensional object of a modeling target indicated by design data in a simulation space, and each has a specific shape based on a modeling performance value of a three-dimensional printer; setting a first flag indicating whether a part of a shape of the three-dimensional object is present to each of the portion sections indicated by the portion section data, based on an overlapping degree between each of the portion sections and the three-dimensional object; and creating modeling data indicating the three-dimensional object obtained by arranging, in the respective portion sections having the first flag indicating that the part of the shape of the three-dimensional object exists, a three-dimensional object corresponding to the specific shape of the respective portion sections.

### CROSS-REFERENCE TO RELATED APPLICATION

This application is based upon and claims the benefit of priority of the prior Japanese Patent Application No. 2015-014638, filed on Jan. 28, 2015, the entire contents of which are incorporated herein by reference.

### FIELD

The embodiments discussed herein are related to a modeling data creation method and an information processing device.

### BACKGROUND

A three-dimensional printer (hereinafter referred to as a 3D printer) is a rapid prototyping (RP) device that models a three-dimensional shape.

A technique in the related art is discussed in Japanese Laid-open Patent Publication No. 2002-248692, Japanese Laid-open Patent Publication No. 2002-236710, Japanese Laid-open Patent Publication No. 2011-39695, or Japanese Laid-open Patent Publication No. 2012-101443.

### SUMMARY

According to an aspect of the embodiments, a modeling data creation method, includes: creating, by a computer, portion section data indicating portion sections which are obtained by dividing a space enclosing a three-dimensional object of a modeling target indicated by design data in a simulation space, and each has a specific shape based on a modeling performance value of a three-dimensional printer; setting a first flag indicating whether a part of a shape of the three-dimensional object is present to each of the portion sections indicated by the portion section data, based on an overlapping degree between each of the portion sections and the three-dimensional object; and creating modeling data indicating the three-dimensional object obtained by arranging, in the respective portion sections having the first flag indicating that the part of the shape of the three-dimensional object exists, a three-dimensional object corresponding to the specific shape of the respective portion sections.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of an operation of an information processing device;

FIGS. 2A and 2B illustrate an example of modeling by a 3D printer;

FIG. 3 illustrates an example of a hardware configuration of an information processing device;

FIG. 4 illustrates an example of a functional configuration of an information processing device;

FIGS. 5A and 5B illustrate an example of 3D data;

FIG. 6 illustrates an example of shape recognition accuracy;

FIG. 7 illustrates an example of modeling accuracy;

FIG. 8 illustrates an example of extraction of a surface and edges of the surface;

FIG. 9 illustrates an example of a maximum gap;

FIG. 10 illustrates an example of correction;

FIG. 11 illustrates an example of correction;

FIGS. 12A and 12B illustrate an example of correction of a modeling start position;

FIG. 13 illustrates an example of division;

FIG. 14 illustrates an example of confirmation of whether a three-dimensional object is present;

FIGS. 15A and 15B illustrate an example of setting of flags;

FIG. 16 illustrates an example of a three-dimensional object obtained by combining three-dimensional objects;

FIGS. 17A and 17B illustrate an example of a display;

FIG. 18 illustrates an example of modeling data creation processing;

FIG. 19 illustrates an example of modeling data creation processing; and

FIG. 20 illustrating an example of modeling data creation processing.

### DESCRIPTION OF EMBODIMENTS

A modeling scheme of 3D printers includes an inkjet scheme, light curing scheme, paper laminate, powder curing or the like. In 3D printers, using 3D data that is an intermediate file generated by converting a three-dimensional shape that is created by 3D computer aided design (CAD), or the like as input information, the modeling is performed in accordance with the three-dimensional shape indicated by the 3D data.

For example, simulation is performed in accordance with modeling accuracy of the 3D printer, and a failure at the time of modeling is displayed.

For example, in a case where 3D data usable in the 3D printer is generated, when a component included in a three-dimensional object modeled by the 3D printer corresponds to a reference of a modeling failure, the component is automatically changed to a prototype of the component, which has a shape obtained by simplifying the central part of the component.

For example, an operation input for specifying one or more division instruction surfaces used to perform division of a three-dimensional object is accepted. 3D data is processed so that the three-dimensional object is divided into division areas that are defined by a certain gap width in accordance with 3D modeling resolution of the 3D printer and the division instruction surfaces.

For example, by characteristic information including size information or the like, which indicates the size of a three-dimensional object allowed to be modeled by a modeling device, slice data is obtained that is used to model a three-dimensional object having an optimal size corresponding to the size information of the modeling device.

For example, a modeling result may not be grasped unless the modeling is performed by the 3D printer practically.

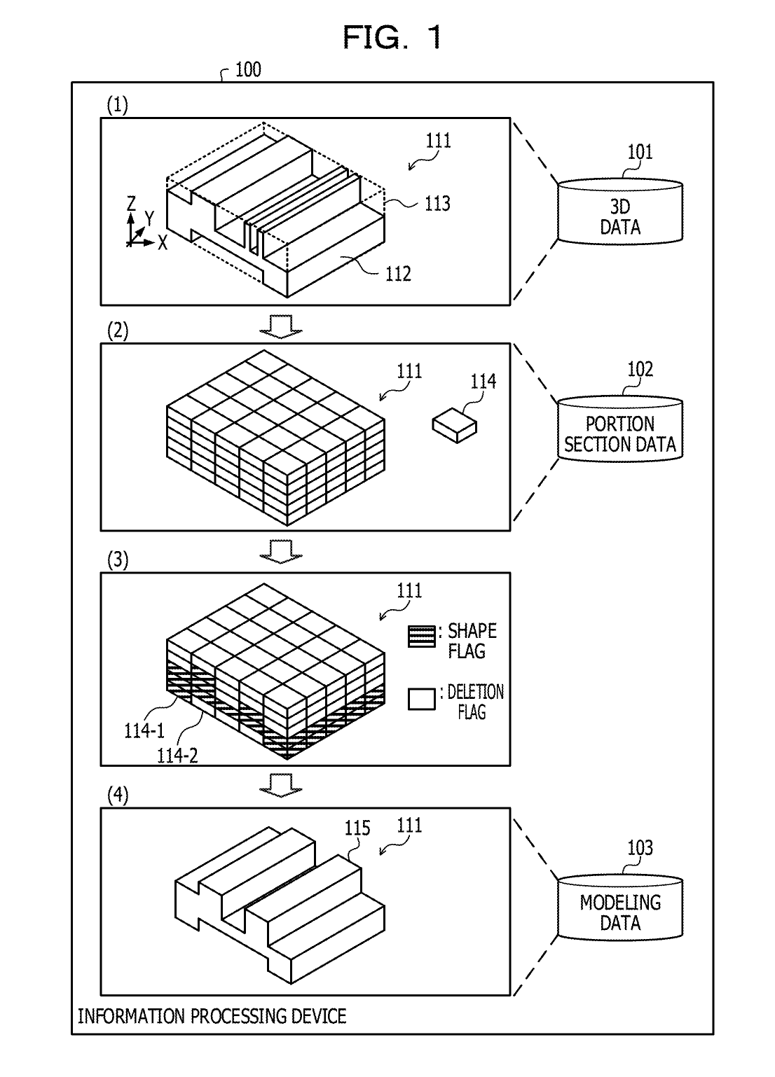

FIG. 1 illustrates an example of an operation of an information processing device. An information processing device 100 may be a computer that predicts a shape when a three-dimensional object 112 provided on a simulation space 111 is modeled by a 3D printer. The simulation space 111 is a virtual three-dimensional space in which the simulation is performed in the computer. For example, the simulation space 111 is a space virtually set in the information processing device 100 by the CAD used to design a three-dimensional assembly. For example, a three-dimensional Cartesian coordinate system including an X axis, a Y axis, and a Z axis is defined in the simulation space 111. The three-dimensional object may include a product, a component, a test product, a test component, or the like, or a mockup of a building or the like.

In the 3D printer, based on 3D data 101, cross-dividing is performed in the height direction, and materials corresponding to each of cross-divided layers are bound to each other and laminated using light, resin injection, or an adhesive to create a three-dimensional object. Here, an inkjet scheme, a light curing scheme, paper laminate, powder curing, or the like may be applied as the modeling scheme. When the modeling is performed by the 3D printer, the 3D data 101 is output from the 3D-CAD. The 3D data 101 is received in the 3D printer control system, and setting of conditions desired for the modeling such as a modeling layout and material setting is performed. At last, the information such as the 3D data 101 that is to be modeled by the 3D printer and the modeling conditions are output to the 3D printer to create an actual three-dimensional object.

The 3D data 101 is design data indicating the three-dimensional object 112 that is a design target. The 3D data 101 is, for example, a file in which the three-dimensional object is represented by a certain format such as Standard Triangulated Language (STL). When the 3D data 101 is a file of the STL format, the 3D data 101 represents the three-dimensional object by an aggregate of the triangular shapes each having three vertexes. The three vertexes are indicated by coordinate values. The coordinate values include an X component value, a Y component value, and a Z component value in the simulation space 111 defined by an X axis, a Y axis, and a Z axis.

As described above, in the 3D printer, when an input of the 3D data 101 is accepted, the modeling may be performed easily. For example, when the modeling is performed by the 3D printer, in a case such as a case where a three-dimensional object is broken, a case where a fine shape is corrupted, or the like, an unintended shape may be modeled. The case in which the three-dimensional object is broken includes, for example, a case in which a thick portion is cracked or deformed due to a hollow. When the modeling is not performed by the 3D printer, the shape to be modeled may not be grasped. Therefore, when an unintended shaped is modeled, the modeling may be performed again, thereby causing additional cost of a modeling material, a modeling time, and the like.

The information processing device 100 generates modeling data 103 indicating the three-dimensional object 112 obtained by respectively arranging and combining three-dimensional objects having the shapes of portion sections 114 obtained by dividing a space 113 enclosing the three-dimensional object 112 in accordance with modeling performance, in the locations of the portion sections 114, based on overlapping degrees between the three-dimensional object 112 and the respective portion sections 114. Therefore, a modeling result may be grasped before the actual modeling of the 3D printer.

The information processing device 100 generates portion section data 102 indicating a plurality of portion sections 114 obtained by dividing the space 113, and each of which has a certain shape based on the modeling performance value of the 3D printer. The space 113 is a space enclosing the three-dimensional object 112 that is a modeling target indicated by the 3D data 101 in the simulation space 111. The modeling performance value is, for example, a minimum modeling distance in which the modeling is allowed to be performed by a specified 3D printer. Therefore, the certain shape may be, for example, a cube. The space 113 enclosing the three-dimensional object 112 that is the modeling target may be, for example, the entire space 113 defined by the 3D printer, in which the modeling is allowed to be performed. In addition, as illustrated in (1) of FIG. 1, the space 113 enclosing the three-dimensional object 112 that is the modeling target may be, for example, a space 113 enclosing the maximum external dimension of the three-dimensional object 112 that is the modeling target, or may be a cube space 113 that is the maximum external dimension of the three-dimensional object 112 that is the modeling target.

The information processing device 100 may generate the portion section data 102 indicating the plurality of portion sections 114, for example, by arranging the certain shapes without clearance in the space 113 enclosing the three-dimensional object 112 that is the modeling target. The information processing device 100 generates a bounding box based on a multiple number of the minimum modeling distance, for example, so that the bounding box encloses the maximum external dimension of the three-dimensional object 112 that is the modeling target, and divides the generated bounding box into certain shapes. As a result, the information processing device 100 may generate the portion section data 102 indicating the plurality of portion sections 114.

For example, as illustrated in (2) of FIG. 1, on the simulation space 111, the cubes that are the certain shapes may be arranged without clearance.

The information processing device 100 sets a flag indicating whether at least a part of the shape of the three-dimensional object 112 is present, for each of the plurality of portion sections 114 indicated by the generated portion section data 102, based on an overlapping degree between the three-dimensional object 112 and each of the portion sections 114. The information processing device 100 sets a flag indicating that at least a part of the shape of the three-dimensional object 112 exists, to a portion section 114, for example, when an overlapping degree between the portion section 114 and the three-dimensional object 112 is a certain ratio or more. The information processing device 100 sets a flag indicating that at least a part of the shape of the three-dimensional object 112 does not exist, to a portion section 114, for example, when an overlapping degree between the portion section 114 and the three-dimensional object 112 is less than the certain ratio. In (3) of FIG. 1, the flag indicating that at least a part of the shape of the three-dimensional object 112 exists in a portion section may be referred to as a shape flag, and the flag indicating that at least a part of the shape of the three-dimensional object 112 does not exists in a portion section may be referred to as a deletion flag. The certain ratio may be specified, for example, by a user. The certain ratio may be, for example, 50 [%]. For example, the shape flag is set to a portion section 114-1, and the deletion flag is set to a portion section 114-2.

The information processing device 100 generates the modeling data 103 indicating a three-dimensional object 115 obtained by respectively arranging and combining three-dimensional objects having the shapes of the portion sections, in the portion sections 114 in each of which the set flag indicates that at least a part of the shape of the three-dimensional object 112 exists, from among the plurality of portion sections 114. For example, the information processing device 100 respectively arranges the three-dimensional objects having the 3D shapes of the portion sections 114, in the portion sections 114, on the simulation space 111, for the portion sections 114 to which the shape flags are set. In (4) of FIG. 1, the information processing device 100 generates the modeling data 103 indicating the three-dimensional object 115 obtained by combining the arranged three-dimensional objects having the 3D shapes of the portion sections 114.

As described above, before the modeling is performed by the 3D printer practically, a modeling result may be grasped. Therefore, occurrence of re-modeling or the like is reduced, and a reduction in cost of a modeling material and a modeling time may be achieved.

For example, the major cause of generation of an unintended three-dimensional object includes a quality of the 3D data 101 and the performance of the 3D printer.

A surface normal vector of the 3D data 101 or a permissible value between adjacent surfaces may be different depending on shape accuracy or conversion performance of the 3D-CAD, or shape recognition accuracy of the 3D printer control system, so that the 3D data 101 including a failure may be generated. For example, as a shape becomes complicated such as a free-form surface, the 3D data may include more failures. When the modeling is performed by the 3D printer based on the 3D data 101 including a failure, the modeling may be performed with an unintended shape such as the broken shape.

For example, setting of the modeling accuracy of the 3D printer is performed, and a shape to be modified is considered from a failure shape at the time of modeling by the simulation based on the set modeling accuracy, and the shape is modified manually using the 3D-CAD. For example, in the method, the modification is performed on the 3D-CAD based on the simulation result and is repeated until there is no failure, so that it may be desirable that the user has the high degree of operation skill of the 3D-CAD. A time is taken for the modification and the like, so that the 3D printer may not be utilized easily.

For example, in a case where 3D data usable in the 3D printer is generated, when a component included in the three-dimensional object that is to be modeled by the 3D printer corresponds to a reference of a modeling failure, the component is automatically changed to a prototype of the component, which has a shape obtained by simplifying the central part of the component. In this case, in components other than the reference of the modeling failure that is set in advance, and the entire three-dimensional object that is obtained by assembling the components, a modeling result may not be grasped unless the modeling is performed by the 3D printer practically.

The information processing device 100 corrects the positions of vertexes so that a distance between a vertex of an edge of a surface and a vertex of an edge of a further surface, which is the closest to the edge of the surface, becomes within a permissible range. Therefore, occurrence in which the shape is broken, and an unintended shape is modeled may be reduced. As illustrated in FIG. 1, the information processing device 100 generates the modeling data 103 indicating the three-dimensional object 115 obtained by respectively arranging and combining three-dimensional objects having the shapes of the portion sections 114 obtained by dividing the space 113 enclosing the three-dimensional object 112 in accordance with the modeling performance, in the locations of the portion sections 114, based on overlapping degrees between the three-dimensional object 112 and the respective portion sections 114. Therefore, a modeling result may be grasped before the modeling is performed by the 3D printer practically.

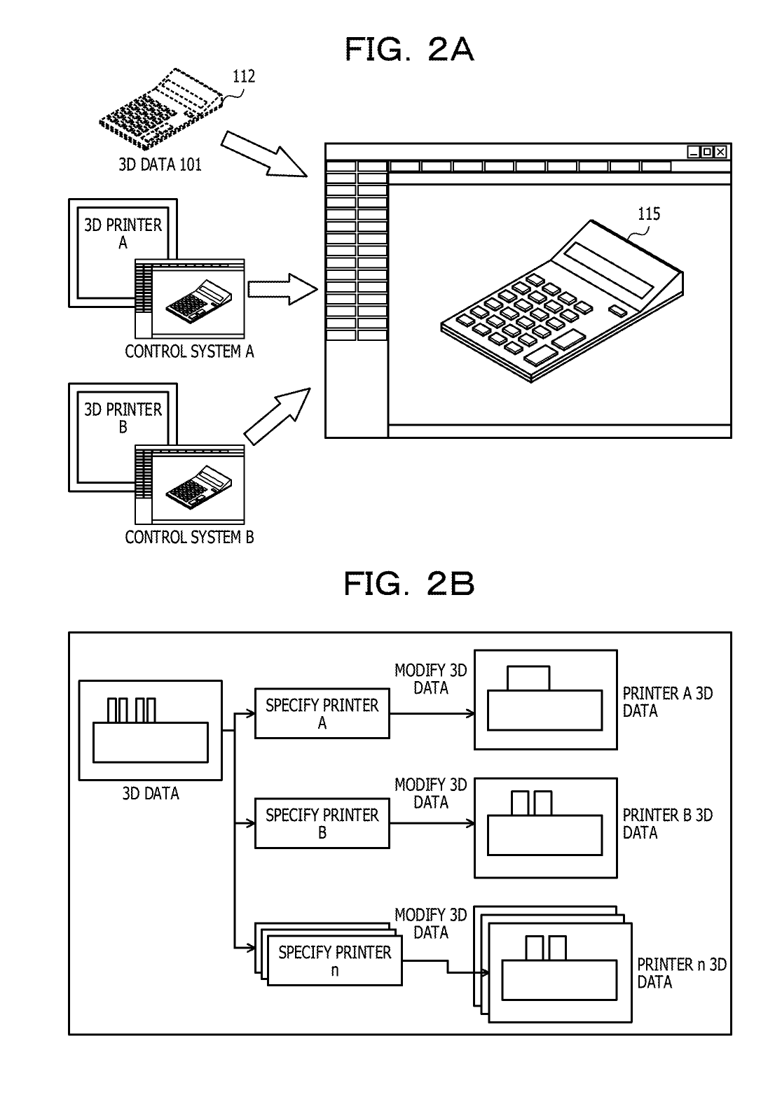

FIGS. 2A and 2B illustrate an example of modeling by a 3D printer. As illustrated in FIG. 2A, the information processing device 100 generates modeling data indicating the three-dimensional object 115 when the three-dimensional object 112 indicated by the 3D data 101 is modeled by a specified 3D printer, based on the 3D data 101.

The modeling accuracy and the shape recognition accuracy may be different depending on the 3D printer. For example, as illustrated in FIG. 2B, in a case of a printer A, four projections become a single projection, and in a case of a printer B, four projections become two projections, so that the modeling shape may be different depending on a 3D printer even with the same 3D data 101.

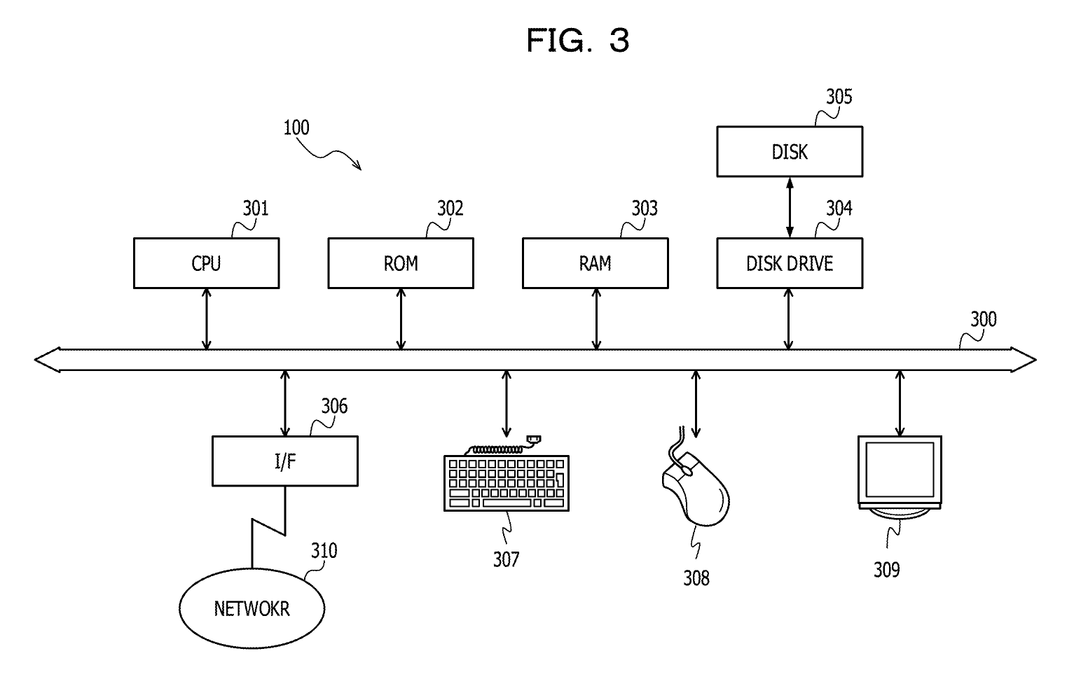

FIG. 3 illustrates an example of a hardware configuration of an information processing device. In FIG. 3, the information processing device 100 includes a central processing unit (CPU) 301, a read only memory (ROM) 302, a random access memory (RAM) 303, a disk drive 304, and a disk 305. In addition, the information processing device 100 includes an interface (I/F) 306, a keyboard 307, a mouse 308, and a display 309. The CPU 301, the ROM 302, the RAM 303, the disk drive 304, the I/F 306, the keyboard 307, the mouse 308, and the display 309 are coupled to each other through a bus 300.

The CPU 301 controls the entire information processing device 100. The ROM 302 stores a program such as a boot program. The RAM 303 is used as a working area of the CPU 301. The disk drive 304 controls read/write of data for the disk 305, in accordance with the control of the CPU 301. The disk 305 stores the data written by the control of the disk drive 304. As the disk 305, a magnetic disk, an optical disk, or the like may be used.

The I/F 306 is coupled to a network 310 such as a local area network (LAN), a wide area network (WAN), or the Internet, through a communication line, and coupled to a further device through the network 310. The I/F 306 administers the network 310 and an internal interface, and controls input/output of data from and to an external device. As the I/F 306, for example, a modem, a LAN adapter, or the like may be employed.

Each of the keyboard 307 and the mouse 308 is, for example, an interface that performs input of various pieces of data by an operation of the user. The display 309 is a display device that displays data in response to an instruction of the CPU 301.

In the information processing device 100, for example, an input device that may capture an image and a video from a camera, an input device that may capture audio from a microphone, and the like, may be provided. In the information processing device 100, for example, an output device such as a printer may be also provided.

In the information processing device 100, for example, an I/F through which the information processing device 100 is allowed to be coupled to the 3D printer may be provided. The information processing device 100 may be coupled to the 3D printer, for example, through the network 310.

In the configuration of FIG. 3, the information processing device 100 may be a desktop-type personal computer (PC) or a laptop PC, but the embodiment is not limited to such an example, and the information processing device 100 may be a server. When the information processing device 100 is a server, for example, the information processing device 100 may access a device that the user is allowed to operate through the network 310. In this case, a processing result of each piece of processing may be stored, for example, in a storage device such as the ROM 302, the RAM 303, or the disk 305 of the information processing device 100, or may be stored in a storage device of the device that the user is allowed to operate. The information processing device 100 may display the processing result on the display 309 or the like included in the device that the user is allowed to operate, through the network 310.

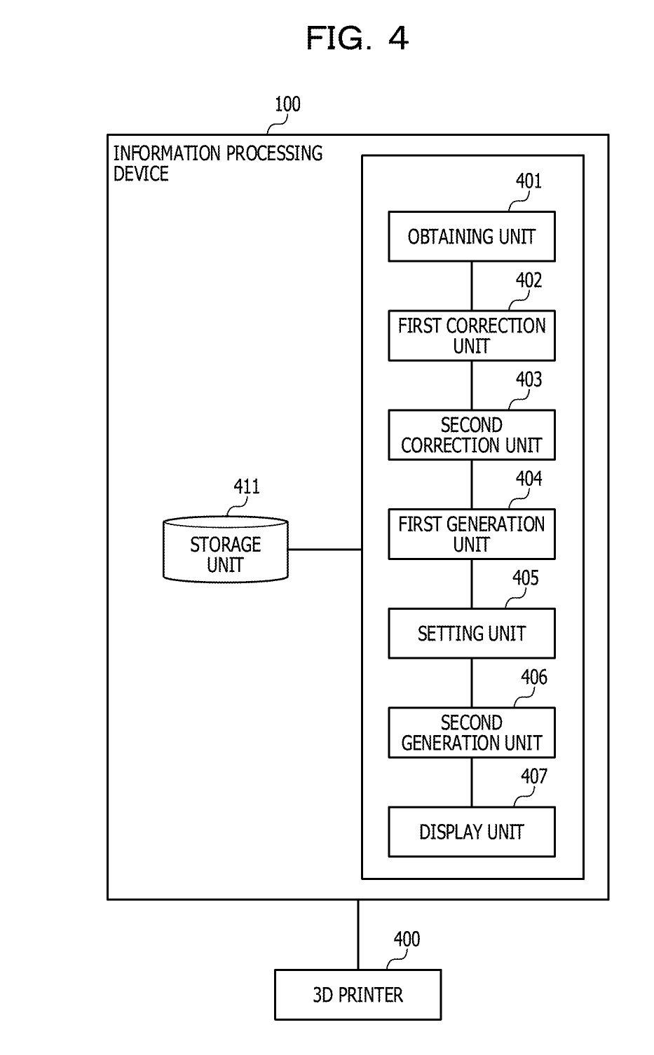

FIG. 4 illustrates an example of a functional configuration of an information processing device. The information processing device 100 includes an obtaining unit 401, a first correction unit 402, a second correction unit 403, a first generation unit 404, a setting unit 405, a second generation unit 406, and a display unit 407. Processing of the control units of the obtaining unit 401 to the display unit 407 may be coded to a program stored, for example, in a storage unit 411 such as the ROM 302, the RAM 303, or the disk 305 that the CPU 301 illustrated in FIG. 3 is allowed to access. The CPU 301 reads the program from the storage unit 411, and executes the processing coded to the program. As a result, the processing of the control units is achieved. The processing results of the control units may be stored, for example, in the storage unit 411 such as the ROM 302, the RAM 303, or the disk 305.

The information processing device 100 may be coupled to the 3D printer 400, for example, through the I/F which is able to be coupled to the 3D printer 400, or through the network 310.

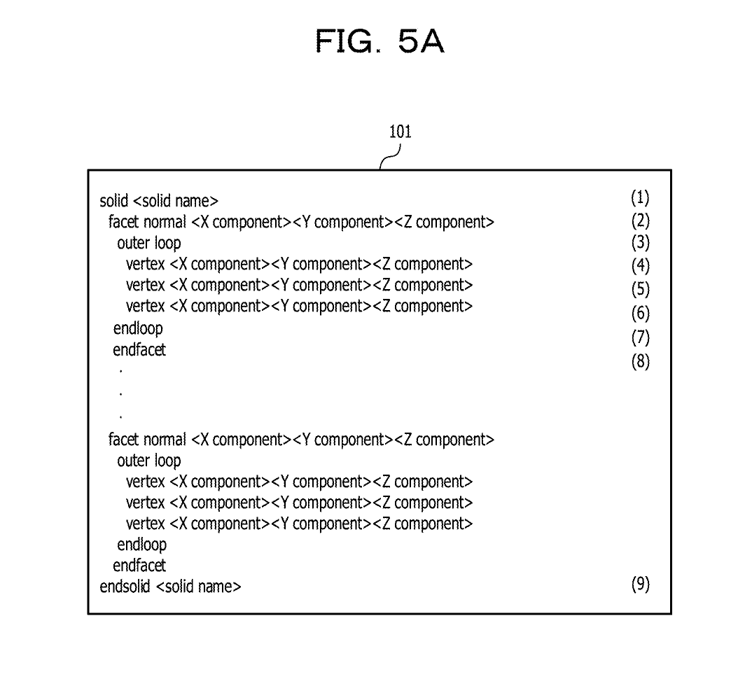

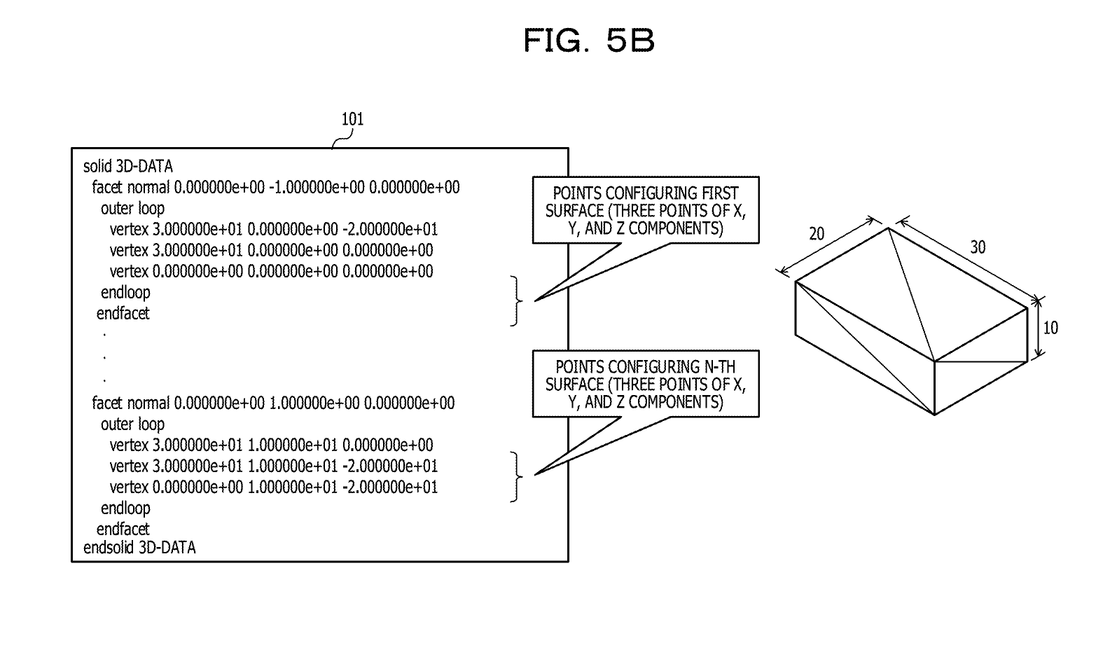

FIGS. 5A and 5B illustrate an example of 3D data. For example, as the 3D data 101, an STL file format may be used. In (1) of FIG. 5A, a character string indicating a solid name is described. In (2) of FIG. 5A (2), components of surface normal vectors of a triangular shape are described. In (3) of FIG. 5A, a start symbol of points configuring a triangular shape is described.

In (4) to (6) of FIG. 5A, components of the points configuring the triangular shape is described. In (7) of FIG. 5A, an end symbol of the points configuring the triangular shape is described. In (8) of FIG. 5A, an end symbol of a surface having the triangular shape is described. In (9) of FIG. 5A, an end symbol of the solid is described.

In FIG. 5B, a sample model of a rectangular solid having the respective lengths 30, 10, and 20 of X, Y, and Z is illustrated. For each surface, points configuring a surface are described. As illustrated in FIG. 5B, in the 3D data 101, points included in the first surface to points included in the N-th surface are described.

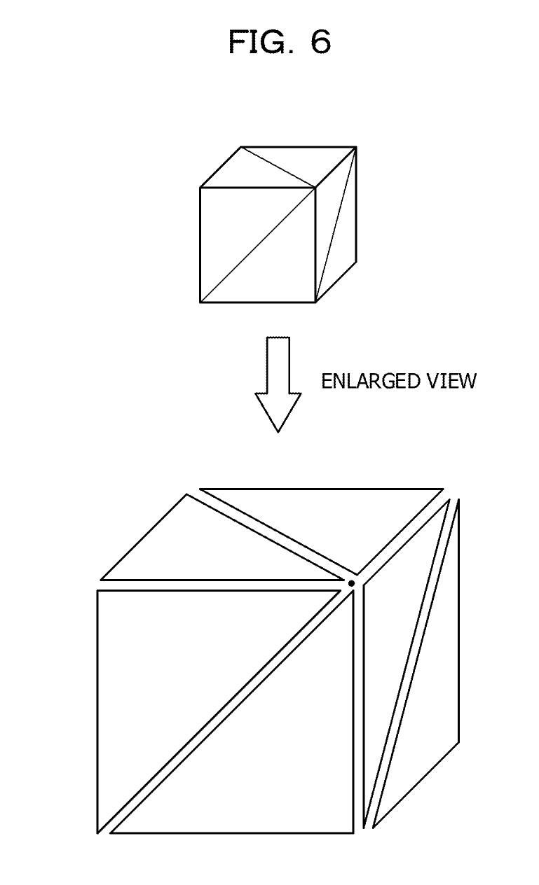

FIG. 6 illustrates an example of a shape recognition accuracy. The shape recognition accuracy is, for example, accuracy used to recognize a shape configuring a three-dimensional object in the 3D printer 400 or a system that controls modeling so as to be accompanied with the 3D printer 400.

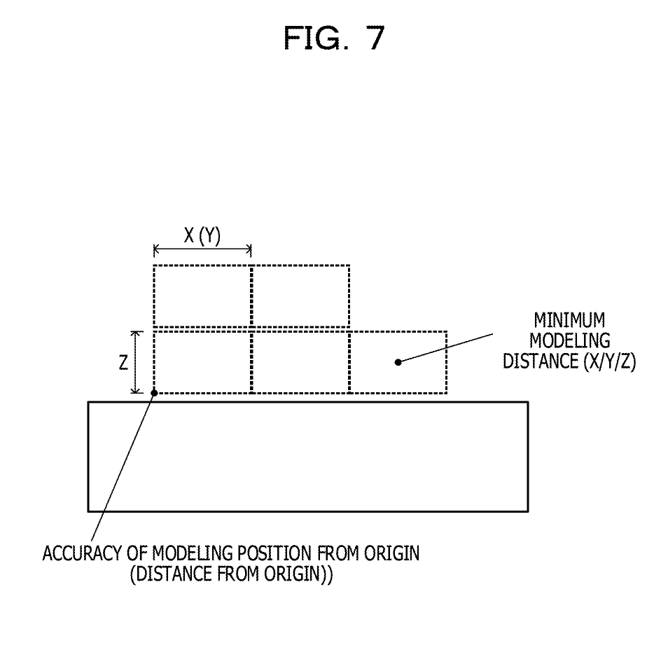

FIG. 7 illustrates an example of modeling accuracy. The modeling accuracy is resolution of the 3D printer 400. In the 3D printer 400, the origin coordinates of the system are defined. The modeling accuracy may include minimum modeling distances in the respective XYZ directions and the position accuracy in the XY directions. The modeling accuracy may include a maximum modeling enabling space.

The obtaining unit 401 obtains the 3D data 101. For example, the 3D data 101 may be obtained from the storage device such as the ROM 302, the RAM 303, or the disk 305. The 3D data 101 may be obtained from a further device through a network. In order to obtain the 3D data 101, an input of the 3D data 101 may be accepted by an operation of the user through the keyboard 307, the mouse 308, or the like.

The obtaining unit 401 obtains information indicating the type of a 3D printer 400 used for the modeling. The obtaining unit 401 may obtain information indicating the type of the 3D printer 400, for example, by accepting an input of specification of the 3D printer 400 used for the modeling by the operation of the user through the keyboard 307 and the mouse 308.

The shape of the three-dimensional object 112 indicated by the 3D data 101 is corrected by the first correction unit 402. For example, whether the 3D data 101 is used as is or the 3D data 101 is used so that the shape of the three-dimensional object 112 indicated by the 3D data 101 is corrected may be accepted by an instruction from the user.

The obtaining unit 401 obtains shape recognition accuracy from the 3D printer control system of an specified 3D printer 400, and store the shape recognition accuracy in the storage unit 411. The obtaining unit 401 may select shape recognition accuracy of the specified 3D printer 400, from a library of shape recognition accuracy. For example, as the shape recognition accuracy, a permissible value of a gap between an edge of a surface and an edge of a further surface, for example, a value of 0.1 [mm] or less may be obtained. The edge of the surface is an edge configuring the surface.

The first correction unit 402 selects a certain surface from the three-dimensional object 112 indicated by the 3D data 101 in order. The first correction unit 402 extracts edges of the selected surface.

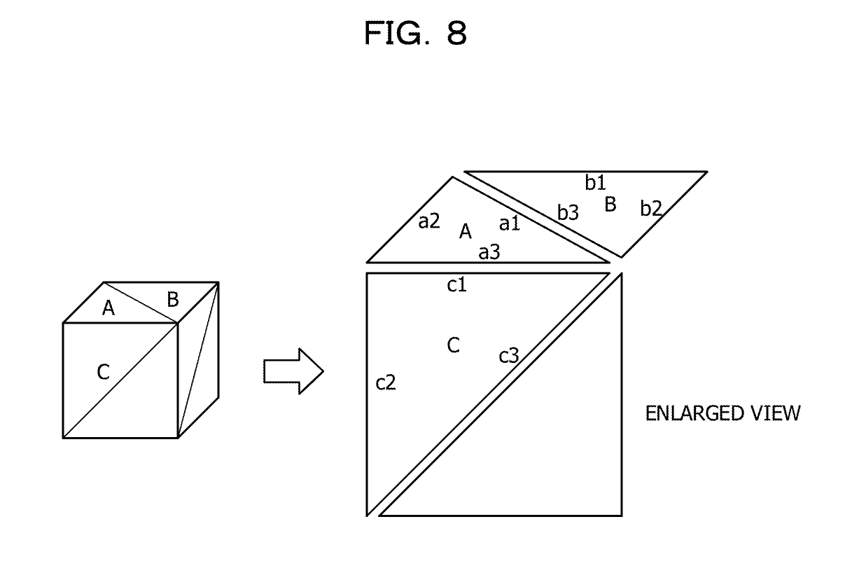

FIG. 8 illustrates an example of extraction of a surface and edges of the surface. For example, the first correction unit 402 selects a surface A and extracts an edge a1 of the surface A.

The first correction unit 402 extracts an edge of a surface, which is the closest to the extracted edge. The edge of the surface, which is the closest to the edge a1, is an edge b3 of a surface B. The first correction unit 402 measures a gap between vertexes of the extracted edges to calculate a maximum gap.

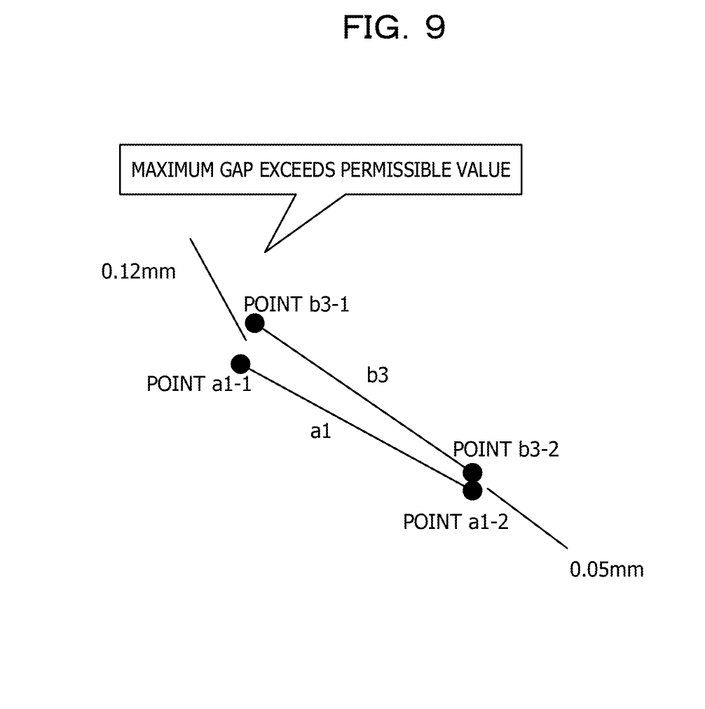

FIG. 9 illustrates an example of a maximum gap. A gap between a vertex a1-1 of the edge a1 and a vertex b3-1 of the edge b3 is 0.12 [mm]. A gap between a vertex a1-2 of the edge a1 and a vertex b3-2 of the edge b3 is 0.05 [mm]. Therefore, the maximum gap is 0.12 [mm].

The first correction unit 402 determines whether the calculated maximum gap is within the range of the permissible value for the gap of the shape recognition accuracy. For example, the permissible value is a value of 0.1 [mm] or less, so that, in FIG. 9, the first correction unit 402 determines that the maximum gap is not within the range of the permissible value.

When the first correction unit 402 determines that the maximum gap is within the range of the permissible value, the first correction unit 402 does not correct the vertex coordinates, based on the 3D data 101. When the first correction unit 402 determines that the maximum gap is not within the range of the permissible value, the first correction unit 402 corrects the vertex coordinates so that the maximum gap becomes the maximum value of the permissible value, based on the 3D data 101.

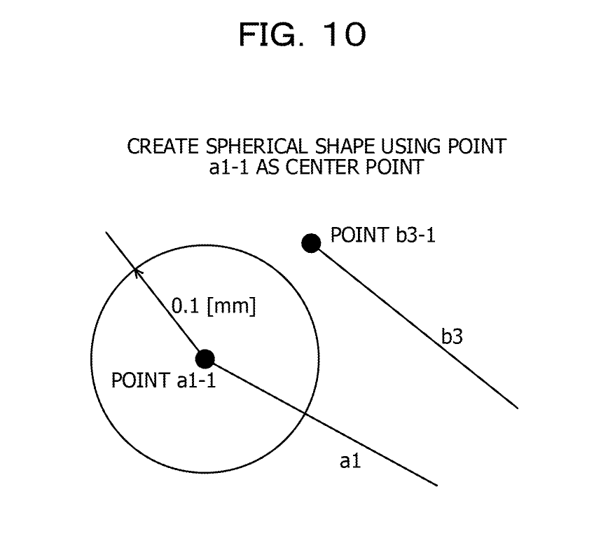

FIG. 10 illustrates an example of correction. The first correction unit 402 creates, for example, a spherical shape with a radius of 0.1 [mm] using the point a1-1 as the center point because the gap between the point a1-1 and the point b3-1 is 0.12 [mm], and is not within the range of the permissible value.

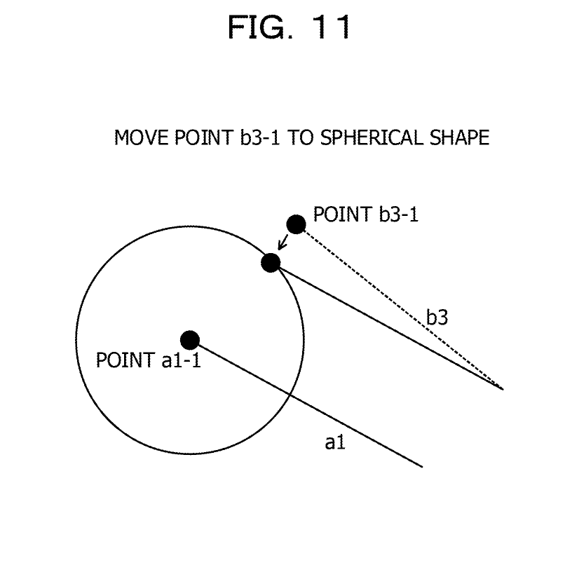

FIG. 11 illustrates an example of correction. The first correction unit 402 calculates coordinates of the ridge line of the spherical shape, which are the closest to the point b3-1. The first correction unit 402 replaces the coordinates of the point b3-1 included in the 3D data 101 with the calculated coordinates. Therefore, the edge b3 is changed to an edge that passes through from the new point b3-1 to the point b3-2. The vertex of the edge b3 illustrated in FIG. 8 is also changed to the new point b3-1.

As described above, the first correction unit 402 calculates a gap between vertexes of the edge of each of the surfaces, and corrects the coordinates of a vertex when the calculated gap is not within the range of the permissible value. For example, the first correction unit 402 may perform the confirmation in order from an edge a2 of the surface A, an edge a3 of the surface A, an edge b1 of surface B, and the like, for example, after the confirmation of the edge al of the surface A is completed. As a result, occurrence in which a shape is broken, and an unintended shape is modeled may be reduced.

The second correction unit 403 corrects the modeling start position.

The second correction unit 403 arranges the three-dimensional object 112 indicated by the 3D data 101 in the maximum modeling enabling space of the 3D printer 400, in the simulation space 111. The 3D data 101 may be the 3D data 101 after the correction by the first correction unit 402, or may be the obtained 3D data 101 as is. The arrangement is processing for determining a direction in which the modeling is performed, so that the arrangement may be performed in a position that is specified by an operation of the user, the origin in the simulation space 111, or a position that is defined in advance.

The second correction unit 403 extracts coordinates of the modeling start position at the time of modeling by the 3D printer 400.

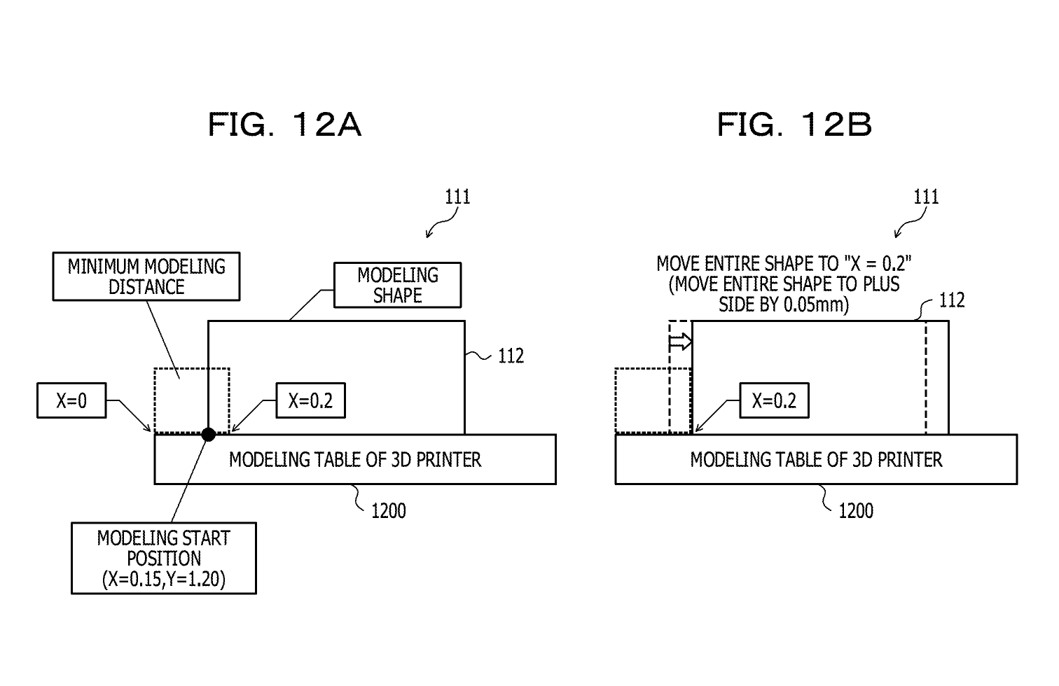

FIGS. 12A and 12B illustrate an example of correction of a modeling start position. As illustrated in FIG. 12A, the modeling start position may be, for example, on a modeling table 1200 of the 3D printer 400, in the simulation space 111, and may be the lower left of the three-dimensional object 112. For example, the modeling start position may correspond to “X=0.15” and “Y=1.20”. The second correction unit 403 determines whether the modeling start position is at a position corresponding to the multiple number of the minimum modeling distance from the origin in the maximum modeling enabling space, for each of the axes defined by the simulation space 111.

As illustrated in FIG. 12A, for the X axis direction, the modeling start position is “X=0.15”, and the position corresponding to the multiple number of the minimum modeling distance from the origin, which is the closest to the modeling start position is “X=0.2”. Therefore, the second correction unit 403 determines that the modeling start position is not at the position corresponding to the multiple number of the minimum modeling distance from the origin in the maximum modeling enabling space, for the X axis.

For the Y axis direction, the modeling start position is “Y=1.20”, and the position corresponding to the multiple number of the minimum modeling distance from the origin, which is the closest to the modeling start position, is “Y=1.20”. Therefore, the second correction unit 403 determines that the modeling start position is at the position corresponding to the multiple number of the minimum modeling distance from the origin in the maximum modeling enabling space, for the Y axis.

For the Z axis direction, the modeling start position is “Z=0”, so that it may be unnecessary that the correction for the X axis and the Y axis is performed.

The second correction unit 403 corrects the arrangement position so that the modeling start position corresponds to the multiple number of the minimum modeling distance. For example, as illustrated in FIG. 12B, the modeling start position in the X axis direction is “X=0.15”, and the position corresponding to the multiple number of the minimum modeling distance from the origin, which is the closest to the modeling start position, is “X=0.2”, so that the second correction unit 403 moves the entire modeling shape in the plus side of the X axis direction by 0.05 [mm]. The second correction unit 403 may set the modeling start position at “X=0” by moving the entire modeling shape in the minus side of the X axis direction by 0.15 [mm].

The first generation unit 404 generates portion section data 102 indicating the plurality of portion sections 114 obtained by dividing the space 113 enclosing the three-dimensional object 112 that is the modeling target, and that have the certain shapes based on the modeling performance value of the 3D printer 400. The space 113 is a space enclosing the three-dimensional object 112 that is the modeling target indicated by design data in the simulation space 111.

The obtaining unit 401 obtains modeling accuracy from the 3D printer control system of the 3D printer 400, and stores the modeling accuracy in the storage unit 411. The obtaining unit 401 may obtain modeling accuracy of the specified 3D printer 400, from a library of modeling accuracy. For example, as the modeling accuracy, the following minimum modeling distance and maximum modeling enabling space of “XYZ”.

The minimum modeling distance: X=0.2 [mm], Y=0.2 [mm], and Z=0.1 [mm], and

The maximum modeling enabling space: X=100 [mm], Y=150 [mm], and Z=80 [mm]

The first generation unit 404 generates the portion section data 102 indicating the plurality of portion sections 114 obtained, for example, by dividing the space 113 having the maximum external dimension of the three-dimensional object 112 that is the design target indicated by the 3D data 101, into certain shapes based on the minimum modeling distance. The space 113 of the maximum external dimension may be, for example, a space 113 based on the multiple number of the minimum modeling distance in the respective directions. The certain shape is, for example, a shape based on the minimum modeling distance. The shape based on the minimum modeling distance may be a sphere, a cylinder, a cone, or a polyhedron. For example, the space 113 of the maximum external dimension may be a rectangular solid. The first generation unit 404 performs the division into the certain shapes based on the surface of the space 113 of the maximum external shape.

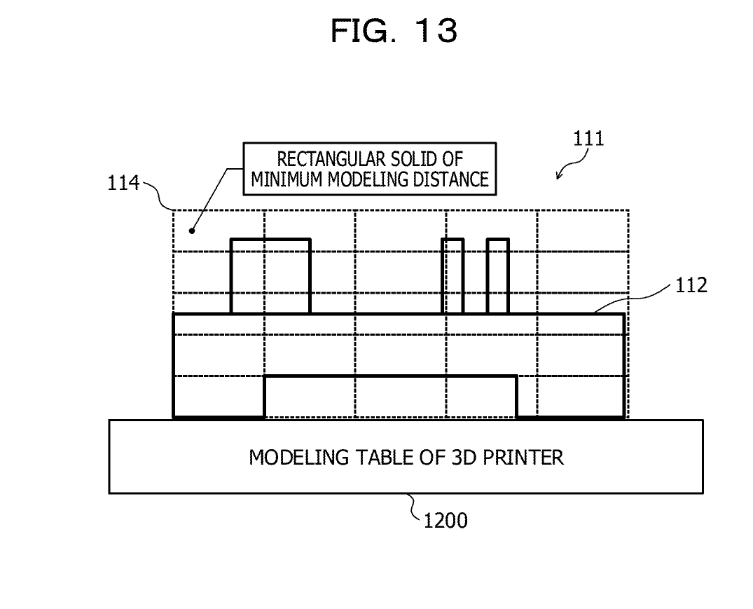

FIG. 13 illustrates an example of division. In FIG. 13, the space 113 is divided into rectangular solids. The space 113 of the maximum external dimension of the three-dimensional object 112 provided on the modeling table 1200 of the 3D printer 400 in the simulation space 111 is divided into the plurality of portion sections 114 using the rectangular solids having the minimum modeling distance.

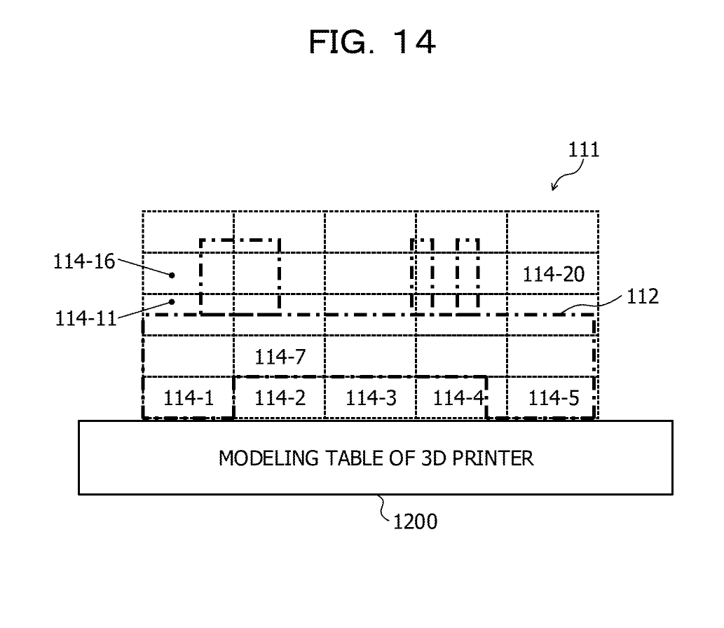

FIG. 14 illustrates an example of determination of whether a three-dimensional object is present. The setting unit 405 determines, for each of the plurality of portion sections 114, whether at least a part of the three-dimensional object 112 that is the design target is included in the portion section 114. As illustrated in FIG. 14, for example, the setting unit 405 may perform the determination in order from the portion section 114-1. For example, examples of the portion section 114 including at least a part of the three-dimensional object 112 and the portion section 114 not including a part of the three-dimensional object 112 are described below. For example, there is a portion section 114 in addition to the following examples of the portion sections 114, but, for convenience, the description may be omitted.

The portion section 114 including at least a part of the three-dimensional object 112: portion section 114-1, portion section 114-4, portion section 114-5, portion section 114-7, portion section 114-11, and portion section 114-16, and

The portion section 114 not including a part of the three-dimensional object 112: portion section 114-2, portion section 114-3, and portion section 114-20

The setting unit 405 sorts the portion sections 114 each including at least a part of the three-dimensional object 112 that is the design target, into the portion section 114 including at least a part of the three-dimensional object 112 by a certain ratio or more and the portion section 114 including at least a part of the three-dimensional object 112 that is the design target by less than the certain ratio. The certain ratio may be, for example, 50 [%].

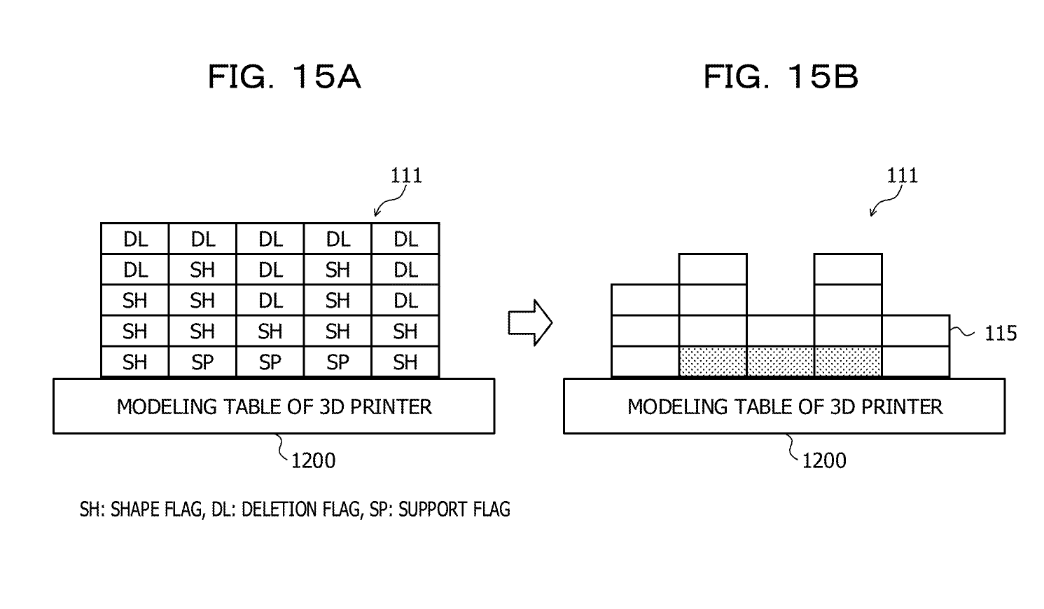

FIGS. 15A and 15B illustrate an example of setting of flags. In FIG. 15A, setting results of flags are illustrated, and in FIG. 15B, the three-dimensional object 115 created based on the set flags is illustrated.

As illustrated in FIG. 15A, the setting unit 405 sets a shape flag, for example, to a portion section 114 including at least a part of the three-dimensional object 112 that is the design target by 50 [%] or more. The setting unit 405 sets a deletion flag, for example, to a portion section 114 including at least a part of the three-dimensional object 112 that is the design target by less than 50 [%].

The setting unit 405 sets a support flag to a portion sections 114 corresponds to the deletion flag, and below which all portion section 114 correspond to the deletion flags, from among the plurality of the portion sections. The setting unit 405 sets a support flag to a portion section 114 that corresponds to the deletion flag, and below which there is no portion section 114, from among the plurality of portion sections 114. In the 3D printer 400, a modeling material is dropped from above. Therefore, a hollow may not be modeled unless a supportable object is arranged at the position of the support flags at the time of modeling as illustrated in FIG. 7.

As illustrated in FIG. 15B, the second generation unit 406 generates the modeling data 103 indicating the three-dimensional object 115 obtained by respectively arranging and combining three-dimensional objects having the shapes of the portion sections 114, in the portion sections 114 in each of which the set flag indicates a part of the three-dimensional object 115 exists, from among the plurality of portion sections 114. For example, the second generation unit 406 arranges a three-dimensional object having the shape of the portion section 114, in the portion section 114 in which the set flag indicates that a part of the shape of the three-dimensional object exists, from among the plurality of portion sections 114.

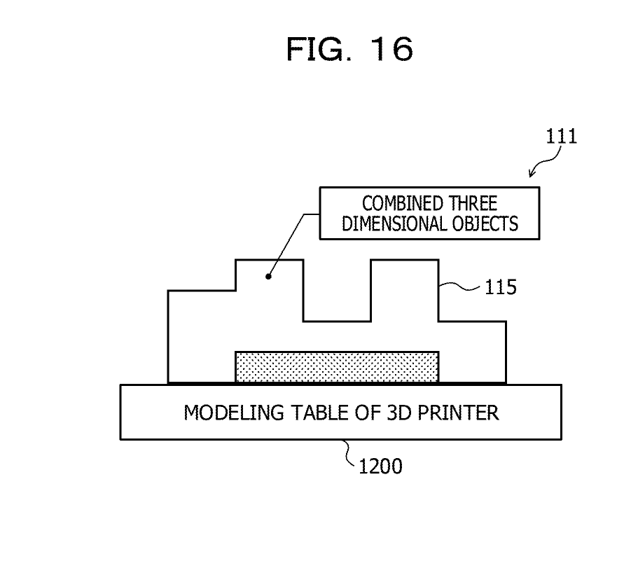

FIG. 16 illustrates an example of a three-dimensional object obtained by combining three-dimensional objects. For example, the second generation unit 406 generates the modeling data 103 indicating the three-dimensional object 115 obtained by combining the arranged three-dimensional objects having the shapes of the portion sections. The second generation unit 406 stores the generated modeling data 103 in the storage unit 411. The data format of the modeling data 103 may be similar to the 3D data 101, and the detailed description may be omitted or reduced.

The display unit 407 displays the three-dimensional object indicated by the modeling data 103 stored in the storage unit 411. For example, the display unit 407 displays the three-dimensional object 115 indicated by the modeling data 103 on the display 309 so as to add information indicating prediction of a shape modeled by the 3D printer 400 to the three-dimensional object 115.

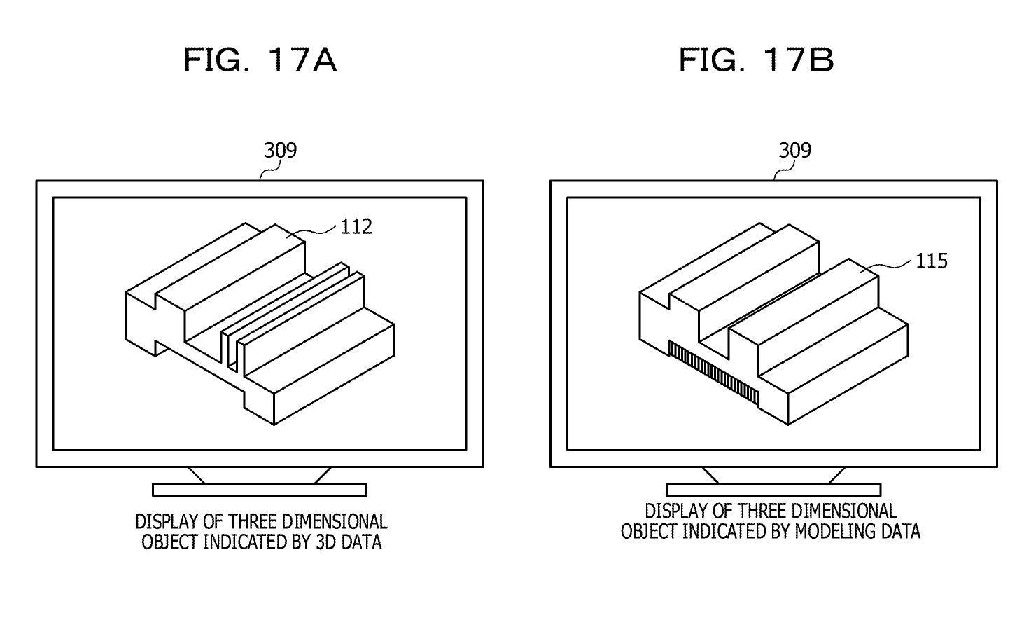

FIGS. 17A and 17B illustrate an example of a display. The display unit 407 may display one of the three-dimensional object 112 indicated by the 3D data 101 and the three-dimensional object 115 indicated by the modeling data 103, based on an instruction from the user. In FIG. 17A, the three-dimensional object 112 indicated by the 3D data 101 is displayed on the display 309, and in FIG. 17B, the three-dimensional object 115 indicated by the modeling data 103 is displayed on the display 309.

The display unit 407 may display both of the three-dimensional object 112 indicated by the 3D data 101 and the three-dimensional object 115 indicated by the modeling data 103 on the display 309 side by side.

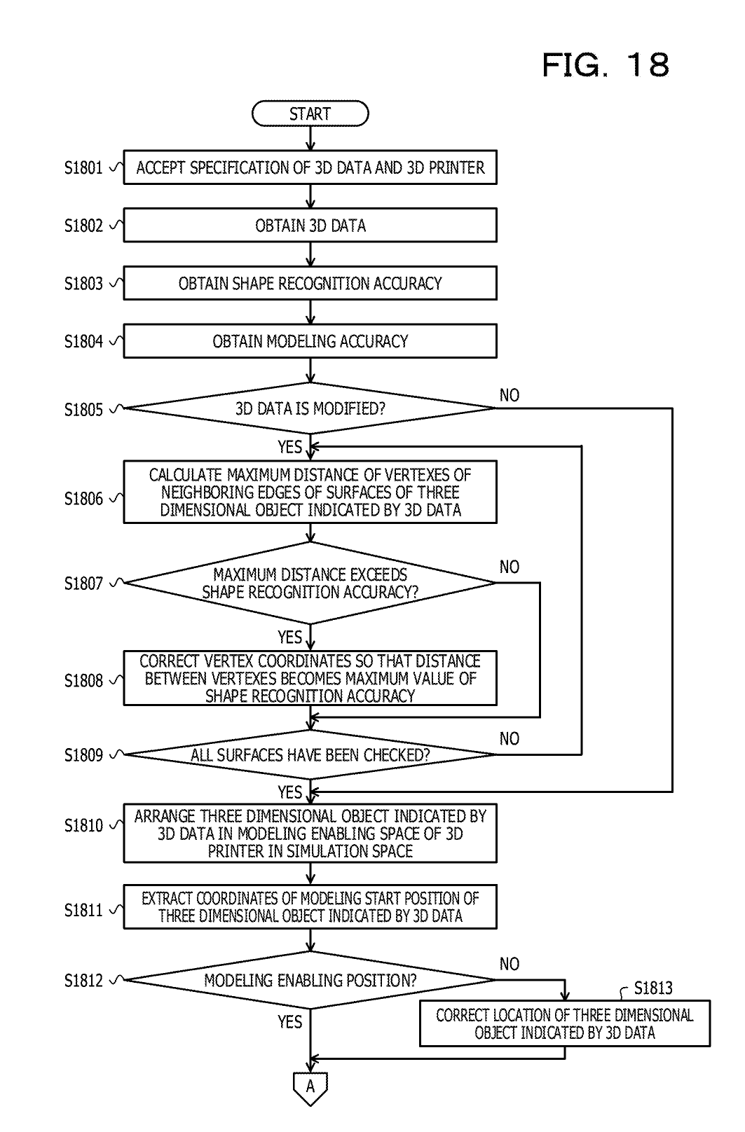

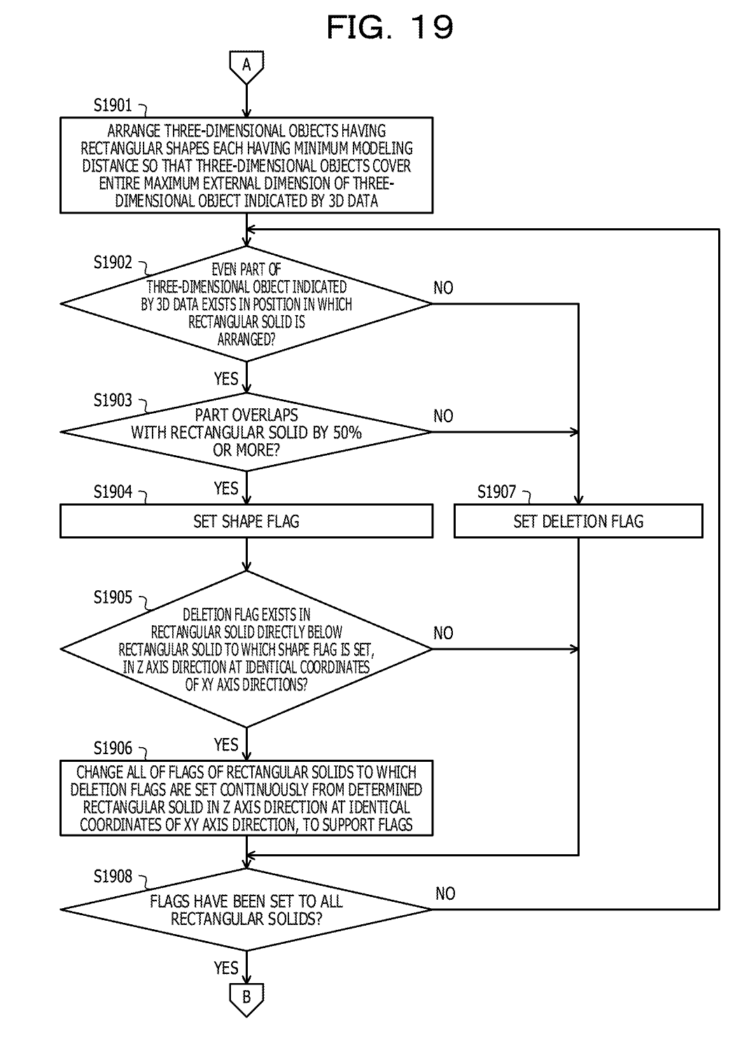

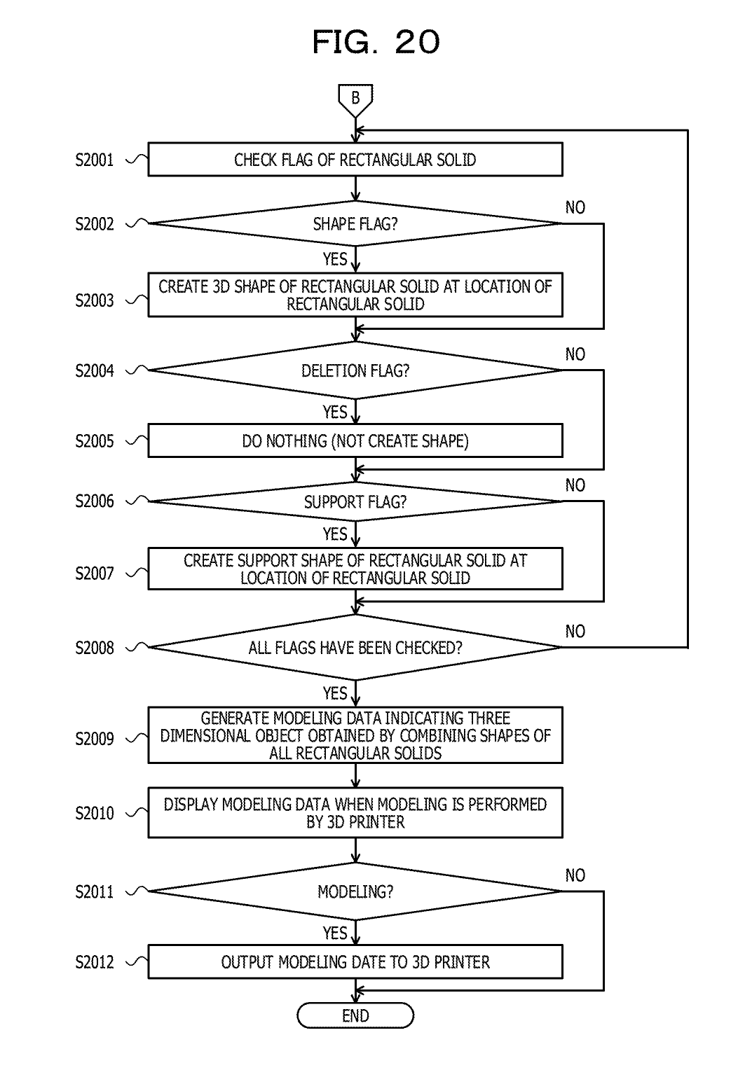

FIGS. 18 to 20 illustrate an example of modeling data creation processing. The information processing device 100 accepts specification of 3D data 101 and a 3D printer 400 (Operation S1801). The information processing device 100 obtains the specified 3D data 101 (Operation S1802). For example, the information processing device 100 obtains the 3D data 101, for example, by reading the 3D data 101 from the storage unit 411.

The information processing device 100 obtains shape recognition accuracy (Operation S1803). The information processing device 100 obtains modeling accuracy (Operation S1804). For example, the information processing device 100 may obtain the shape recognition accuracy and the modeling accuracy from the specified 3D printer 400. The information processing device 100 may obtain the shape recognition accuracy and the modeling accuracy, for example, based on the 3D printer 400 specified from a table including shape recognition accuracy and modeling accuracy for each type of 3D printers 400.

The information processing device 100 determines whether the 3D data 101 is modified (Operation S1805). For example, whether the 3D data 101 is modified may be specified by an operation of the user through the keyboard 307 or the mouse 308. When the information processing device 100 determines that the 3D data 101 is not modified (Operation S1805: No), the processing proceeds to Operation S1810.

When the information processing device 100 determines that the 3D data 101 is modified (Operation S1805: Yes), the information processing device 100 calculates a maximum distance of vertexes of neighboring edges between surfaces of the three-dimensional object 112 indicated by the 3D data 101 (Operation S1806). The surface of the three-dimensional object 112 indicated by the 3D data 101 may be a surface selected from unconfirmed surfaces. The information processing device 100 determines whether the maximum distance exceeds the shape recognition accuracy (Operation S1807). When the information processing device 100 determines that the maximum distance does not exceed the shape recognition accuracy (Operation S1807: No), the processing proceeds to Operation S1809. When the information processing device 100 determines that the maximum distance exceeds the shape recognition accuracy (Operation S1807: Yes), the information processing device 100 corrects the vertex coordinates so that the distance between the vertexes becomes the maximum value of the shape recognition accuracy (Operation S1808).

The information processing device 100 determines whether the confirmation has been made for all surfaces (Operation S1809). When the information processing device 100 determines that not all of the surfaces have been checked (Operation S1809: No), the processing returns to Operation S1806.

When the information processing device 100 determines that all of the surfaces have been checked (Operation S1809: Yes), the information processing device 100 arranges the three-dimensional object 112 indicated by the 3D data 101 in modeling enabling space of the 3D printer 400, in the simulation space 111 (Operation S1810). The information processing device 100 extracts the modeling start position of the three-dimensional object 112 indicated by the 3D data 101 (Operation S1811).

The information processing device 100 determines whether the extracted modeling start position corresponds to a modeling enabling position, based on the modeling accuracy (Operation S1812). Whether the extracted modeling start position corresponds to the modeling enabling position may be determined for each of the axes. When the information processing device 100 determines that the extracted modeling start position corresponds to the modeling enabling position (Operation S1812: Yes), the processing proceeds to Operation S1901. When the information processing device 100 determines that the extracted modeling start position does not correspond to the modeling enabling position (Operation S1812: No), the information processing device 100 corrects the position of the three-dimensional object 112 indicated by the 3D data 101, based on the modeling accuracy (Operation S1813), and the processing proceeds to Operation S1901.

The information processing device 100 arranges the three-dimensional objects having the rectangular shapes each having the minimum modeling distance so that the three-dimensional objects cover the entire maximum external dimension of the three-dimensional object 112 indicated by the 3D data 101 (Operation S1901). As a result, portion section data is generated. The information processing device 100 determines whether at least a part of the three-dimensional object 112 indicated by the 3D data 101 exists in a position in which the rectangular solid is arranged (Operation S1902). When the information processing device 100 determines that at least a part of the three-dimensional object 112 does not exist in the position in which the rectangular solid is arranged (Operation S1902: No), the processing proceeds to Operation S1907.

When the information processing device 100 determines that at least a part of the three-dimensional object 112 exists in the position in which the rectangular solid is arranged (Operation S1902: Yes), the information processing device 100 determines whether the part overlaps with the rectangular solid by 50[%] or more (Operation S1903). When the information processing device 100 determines that the part overlaps with the rectangular solid by 50[%] or more (Operation S1903: Yes), the information processing device 100 sets the shape flag (Operation S1904).

The information processing device 100 determines whether a deletion flag exists in a rectangular solid directly below the rectangular solid to which the shape flag is set, in the Z axis direction at the identical coordinates of the XY axis directions (Operation S1905). When the information processing device 100 determines that the deletion flag exists (Operation S1905: Yes), the information processing device 100 changes all of the flags of the rectangular solids to which the deletion flags are set continuously from the determined rectangular solid in the Z axis direction at the identical coordinates of the XY axis direction, to support flags (Operation S1906), and the processing proceeds to Operation S1908. When the information processing device 100 determines that there is no deletion flag (Operation S1905: No), the processing proceeds to Operation S1908.

In Operation S1903, when the information processing device 100 determines that the part overlaps with the rectangular solid by less than 50[%] (Operation S1903: No), the information processing device 100 sets the deletion flag to the rectangular solid (Operation S1907), and the processing proceeds to Operation S1908.

The information processing device 100 determines whether flags have been set to all of the rectangular solids (Operation S1908). When the information processing device 100 determines that flags have not been set to all of the rectangular solids (Operation S1908: No), the processing returns to Operation S1902. When the information processing device 100 determines that flags have been set to all of the rectangular solids (Operation S1908: Yes), the processing proceeds to Operation S2001.

The information processing device 100 checks the flag of the rectangular solid (Operation S2001). The rectangular solid may be selected from unconfirmed rectangular solids. The information processing device 100 determines whether the flag is a shape flag (Operation S2002). When the information processing device 100 determines that the flag is a shape flag (Operation S2002: Yes), the information processing device 100 creates a 3D shape of the rectangular solid at the position of the rectangular solid (Operation S2003), and the processing proceeds to Operation S2004. After Operation S2003, the processing may proceed to Operation S2008.

When the information processing device 100 determines that the flag is not a shape flag (Operation S2002: No), the information processing device 100 determines whether the flag is a deletion flag (Operation S2004). When the information processing device 100 determines that the flag is not a deletion flag (Operation S2004: No), the processing proceeds to Operation S2006. When the information processing device 100 determines that the flag is a deletion flag (Operation S2004: Yes), the information processing device 100 does nothing (Operation S2005), for example, may not create the shape.

The information processing device 100 determines whether the flag is a support flag (Operation S2006). When the information processing device 100 determines that the flag is not a support flag (Operation S2006: No), the processing proceeds to Operation S2008. When the information processing device 100 determines that the flag is a support flag (Operation S2006: Yes), the information processing device 100 creates a support shape of the rectangular solid at the position of the rectangular solid (Operation S2007).

The information processing device 100 determines whether all flags have been checked (Operation S2008). When the information processing device 100 determines that not all of the flags have been checked (Operation S2008: No), the processing returns to Operation S2001. When the information processing device 100 determines that all of the flags have been checked (Operation S2008: Yes), the information processing device 100 generates modeling data 103 indicating the three-dimensional object 115 that is obtained by combining all of the shapes of the rectangular solids (Operation S2009).

The information processing device 100 displays the three-dimensional object 115 indicated by the modeling data 103 at the time of modeling by the 3D printer 400, on the display unit such as the display 309 (Operation S2010). The information processing device 100 determines whether the modeling is performed (Operation S2011). Whether the modeling is performed may be specified by an operation of the user through the keyboard 307, the mouse 308, or the like. When the information processing device 100 displays the three-dimensional object 115 indicated by the modeling data 103 in Operation S2010, an instruction that causes the user to input whether the modeling is performed may be displayed.

When the information processing device 100 determines whether the modeling is not performed (Operation S2011: No), the information processing device 100 ends a series of pieces of processing. When the information processing device 100 determines whether the modeling is performed (Operation S2011: Yes), the information processing device 100 outputs the modeling data 103 to the 3D printer 400 (Operation S2012), and ends the series of pieces of processing.

The information processing device 100 generates modeling data indicating a three-dimensional object obtained by respectively arranging and combining three-dimensional objects of the shapes of portion sections obtained by dividing a space enclosing the three-dimensional object in accordance with modeling performance, in the positions of the portion section, based on overlapping degrees between a three-dimensional object and the respective portion sections. A modeling result may be grasped before the modeling is performed practically. Therefore, occurrence of remodeling or the like may be reduced, and a reduction in cost of a modeling material and a modeling time may be achieved.

The modeling performance may correspond to a minimum modeling distance in which the modeling is allowed to be performed by a three-dimensional printer. Therefore, a modeling result may be reproduced further accurately before the modeling is performed practically.

When a flag that is set to a portion section directly below a certain portion section indicates that at least a part of the shape of a three-dimensional object does not exist, the information processing device 100 sets a flag indicating differently from whether at least a part of the shape is present, to the portion section directly below the certain portion section. Therefore, a portion that is to be supported may be reproduced.

The information processing device 100 sets a flag in order from the bottom position at the time of modeling of a three-dimensional object indicated by three-dimensional data. Therefore, the portion that is to be supported may be reproduced further accurately.

The information processing device 100 corrects the position of a vertex so that a distance between a vertex of an edge of a surface and a vertex of an edge of a further surface, which is the closest to the edge, becomes within a permissible range. Therefore, occurrence in which an unintended shape such as a broken shape is modeled may be reduced.

A three-dimensional object indicated by design data in a simulation space is arranged in a position based on a reference position of a three-dimensional printer. Therefore, in a position in which the modeling is started, a shape that is to be modeled reliably may be arranged.

The above-described modeling data creation method may be achieved by causing a computer such as a personal computer or a workstation to execute a modeling data creation program that is prepared in advance. The modeling data creation program is recorded to a computer readable recording medium such as a magnetic disk, an optical disk, or a Universal Serial Bus (USB) flash memory, and is read from the recording medium and executed by the computer. The modeling data creation program may be distributed through the network 310 such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A modeling data creation method, comprising:
creating, by a computer, portion section data indicating portion sections which are obtained by dividing a space enclosing a three-dimensional object of a modeling target indicated by design data in a simulation space, and each has a specific shape based on a modeling performance value of a three-dimensional printer;
setting a first flag indicating whether a part of a shape of the three-dimensional object is present to each of the portion sections indicated by the portion section data, based on an overlapping degree between each of the portion sections and the three-dimensional object; and
creating modeling data indicating the three-dimensional object obtained by arranging, in the respective portion sections having the first flag indicating that the part of the shape of the three-dimensional object exists, a three-dimensional object corresponding to the specific shape of the respective portion sections.

2. The modeling data creation method according to claim 1, wherein
the modeling performance value corresponds to a minimum modeling distance for modeling which is defined by the three-dimensional printer.

3. The modeling data creation method according to claim 1, wherein
the first flag indicating that the part of the shape of the three-dimensional object exists in the respective portion sections is set to the respective portion sections when a value indicating the overlapping degree between the three-dimensional object and the respective portion sections is a specific value or more, and
the first flag that indicating that the part of the shape of the three-dimensional object does not exist in the respective portion sections is set to the respective portion sections when the value is less than the specific value.

4. The modeling data creation method according to claim 1, wherein
a second flag is set to one of the portion sections which exists directly below another one of the portion sections where the flag indicates that the part of the shape of the three-dimensional object exists, and has the flag indicates that a part of the shape of the three-dimensional object does not exist.

5. The modeling data creation method according to claim 4, wherein
the modeling data is generated by arranging a three-dimensional object having a shape different from the specific shape of the another one of the portion sections, in the portion section to which the second flag is set.

6. The modeling data creation method according to claim 4, wherein
setting of the second flag is performed in order from a bottom position to an upper position at a time of modeling of the three-dimensional object.

7. The modeling data creation method according to claim 1, further comprising,
correcting the design data, when a distance between a vertex of a side of a first surface included in the three-dimensional object and a vertex of a side of a second surface which is different from the first surface, is included in the three-dimensional object and is closest to the side of the first surface is not within a specific range based on shape recognition accuracy of the three-dimensional printer, such that the design data indicates a new three-dimensional object obtained by moving at least one of the vertex of the side of the first surface or the vertex of the side of the second surface so that the distance becomes within the specific range.

8. The modeling data creation method according to claim 1, wherein
the three-dimensional object is arranged at a position based on a reference position of the three-dimensional printer.

9. An information processing device comprising:
a processor configured to execute a program; and
a memory configured to store the program,
the processor, based on the program, performs operations of:
creating portion section data indicating portion sections which are obtained by dividing a space enclosing a three-dimensional object of a modeling target indicated by design data in a simulation space, and each has a specific shape based on a modeling performance value of a three-dimensional printer;
setting a first flag indicating whether a part of a shape of the three-dimensional object is present to each of the portion sections indicated by the portion section data, based on an overlapping degree between each of the portion sections and the three-dimensional object; and
creating modeling data indicating the three-dimensional object obtained by arranging, in the respective portion sections having the first flag indicating that the part of the shape of the three-dimensional object exists, a three-dimensional object corresponding to the specific shape of the respective portion sections.

10. The information processing device according to claim 9, wherein
the modeling performance value corresponds to a minimum modeling distance for modeling which is defined by the three-dimensional printer.

11. The information processing device according to claim 9, wherein
the first flag indicating that the part of the shape of the three-dimensional object exists in the respective portion sections is set to the respective portion sections when a value indicating the overlapping degree between the three-dimensional object and the respective portion sections is a specific value or more, and
the first flag that indicating that the part of the shape of the three-dimensional object does not exist in the respective portion sections is set to the respective portion sections when the value is less than the specific value.

12. The information processing device according to claim 9, wherein
a second flag is set to one of the portion sections which exists directly below another one of the portion sections where the flag indicates that the part of the shape of the three-dimensional object exists, and has the flag indicates that a part of the shape of the three-dimensional object does not exist.

13. The information processing device according to claim 12, wherein
the modeling data is generated by arranging a three-dimensional object having a shape different from the specific shape of the another one of the portion sections, in the portion section to which the second flag is set.

14. The information processing device according to claim 12, wherein
setting of the second flag is performed in order from a bottom position to an upper position at a time of modeling of the three-dimensional object.

15. The information processing device according to claim 9, wherein the processor performs:
corrects the design data, when a distance between a vertex of a side of a first surface included in the three-dimensional object and a vertex of a side of a second surface which is different from the first surface, is included in the three-dimensional object and is closest to the side of the first surface is not within a specific range based on shape recognition accuracy of the three-dimensional printer, such that the design data indicates a new three-dimensional object obtained by moving at least one of the vertex of the side of the first surface or the vertex of the side of the second surface so that the distance becomes within the specific range.

16. The information processing device according to claim 9, wherein
the three-dimensional object is arranged at a position based on a reference position of the three-dimensional printer.
